(19) United States
(12) Patent Application Publication
(10) Pub. No.: US 2022/0074225 A1
(43) Pub. Date: Mar. 10, 2022

(54) FLEXI-STRIP CONNECTING AWNING SHIELD TO AWNING RAIL

(71) Applicant: Lippert Components, Inc., Elkhart, IN (US)

(72) Inventor: Scott Tibbetts, Elkhart, IN (US)

(21) Appl. No.: 17/466,024

(22) Filed: Sep. 3, 2021

Related U.S. Application Data
(60) Provisional application No. 63/076,201, filed on Sep. 9, 2020.

(51) Int. Cl. E04H 15/10; E04H 15/08

(52) U.S. Cl. CPC E04H 15/10; B60P 3/343; E04H 15/08

(57) ABSTRACT

An awning shield connector connects an awning shield to a structure. The awning shield connector includes an elongated strip of PVC material with a first bead along one side of the elongated strip and shaped to engage an awning rail on the structure, and a second bead along an opposite side of the elongated strip and shaped to engage the awning shield. A third bead for a light strip or the like is positioned between the first and second beads and extends along a length of the elongated strip.

### CROSS-REFERENCES TO RELATED APPLICATIONS

This application claims the benefit of U.S. Provisional Patent Application Ser. No. 63/076,201, filed Sep. 9, 2020, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to an awning shield connector that connects an awning shield to the awning rail on a vehicle or other structure.

Retractable awnings have been mounted on the sides of recreational vehicles and other structures to expand and cover exterior living spaces. Various systems are utilized for mounting and protecting the awning in use and when the vehicle is in transit. It is desirable to protect the awning in transit to limit exposure to environmental elements such as sun, wind, rain, and the like. An existing product is the Solera® Awning Shield from Lippert Components, Inc. The awning shield provides protection for the vinyl or acrylic awning canopy. As the awning retracts, the aluminum shield automatically rolls up around the fabric to protect it against the elements during travel.

Currently, a fabric flexi-strip with multiple polycord inlays connects the awning shield to the vehicle awning rail. The fabric flexi-strip requires folding of the fabric and sewing and/or welding to create the piece. The sewing or welding can be burdensome and hampers manufacturing efficiency.

### SUMMARY

The awning shield connector of the described embodiments is constructed as a one-piece connector that does not require additional assembly or alteration before installing onto the awning system. In some embodiments, the connector is a one-piece elongated strip of PVC material.

The connector of the described embodiments reduces production time, is more durable, is stable over environmental changes, and will not shrink or expand. The one-piece extruded PVC connector replaces the need to wrap and weld fabric around three strings of polycord. The resulting structure can readily join to the mounting rail and the hard shield link, while also providing a third bead for receiving a light strip or the like.

PVC provides an advantage over using other solid, flexible materials like rubber because the PVC slides into the receiving tracks more effectively. The PVC material is rigid and threads nicely, whereas rubber or a less stiff material can bend and bind while trying to slide it into a channel. Also, as mentioned above, the material is stable over environmental temperatures, so the PVC will remain captured in the track (i.e., not shrink) and will not expand to damage the track.

The connector is also provided with a bead for receiving a light strip, which creates illumination under the awning roller area and works when the canopy is open or closed. The light strip bead may be oriented at an intentional angle to aim the lights outward (e.g., at a 45 degree angle) to create a greater illuminated area.

In an exemplary embodiment, an awning shield connector is configured to connect an awning shield to a structure. The awning shield connector includes an elongated strip of PVC material with a first bead along one side of the elongated strip and shaped to engage an awning rail on the structure, a second bead along an opposite side of the elongated strip and shaped to engage the awning shield, and a third bead positioned between the first and second beads and extending along a length of the elongated strip. The first, second and third beads may form an integral part of the elongated strip. In some embodiments, the first and second beads may be positioned along outermost sides of the elongated strip. In this context, the awning shield connector may also include a planar extension section between the first and second beads, where the third bead extends from a stem connected to the planar extension section. The stem and thereby the third bead may be angled relative to the planar extension section. The awning shield connector may also include a light strip assembly detachably connected to the third bead. In this context, the light strip assembly may include a first channel securing a light strip, and a second channel sized to fit over the third bead.

In another exemplary embodiment, an awning shield connector includes a first bead extending along one side of the connector, a second bead extending along an opposite side of the connector, where the first and second beads define outermost sides of the connector, and a planar extension section extending between the first bead and the second bead. A third bead is disposed between the first and second beads and extends along a length of the connector. In some embodiments, the first bead, the second bead, the planar extension, and the third bead are integrally formed. The first bead, the second bead, the planar extension, and the third bead may define an elongated strip formed of PVC material.

In yet another exemplary embodiment, a method of connecting an awning shield to a structure with an awning shield connector includes the steps of (a) sliding the first bead into a channel in an awning rail on the structure; and (b) sliding the second bead into a channel in the awning shield. Step (b) may be practiced before step (a). The method may also include (c) sliding a light strip assembly over the third bead. In this context, where the light strip assembly includes a first channel at one end and a second channel at an opposite end, step (c) may be practiced by sliding the first channel over the third bead. The method may also include securing a light strip in the second channel.

### BRIEF DESCRIPTION OF THE DRAWINGS

These and other aspects and advantages will be described in detail with reference to the accompanying drawings, in which:

FIG. 1 shows an awning shield connected between an awning and a structure;

FIG. 2 shows the awning shield connector connected to an awning shield;

FIG. 3 is a perspective view of the awning shield connector secured between the awning shield and an awning rail; and

FIG. 4 is a plan view of the awning shield connector.

### DETAILED DESCRIPTION

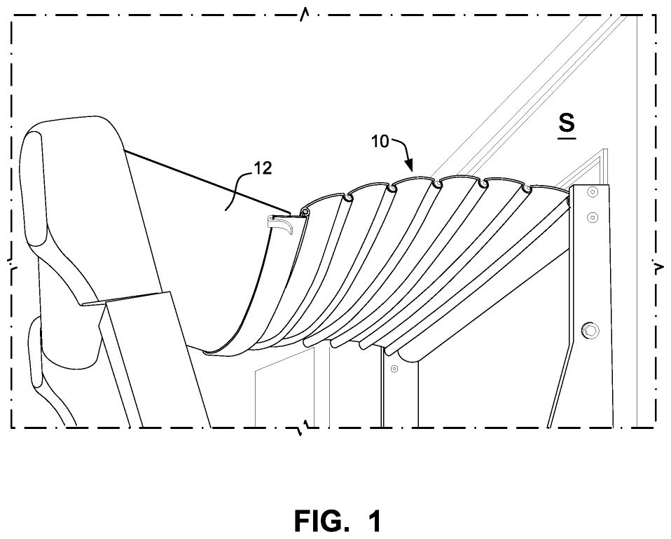

With reference to FIG. 1, an awning shield 10 may be connected at a proximal end of an awning 12. As the awning 12 retracts, the shield 10 automatically rolls up around the fabric to protect it against the elements. A shield connector serves to connect the awning shield 10 to the vehicle or other structure S.

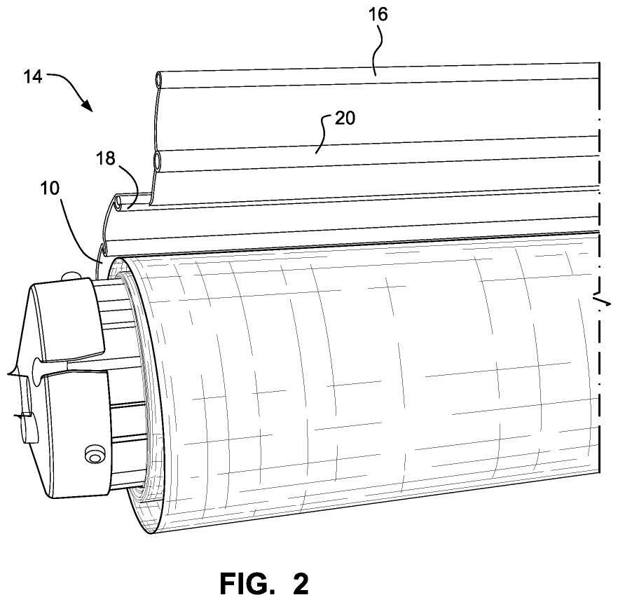

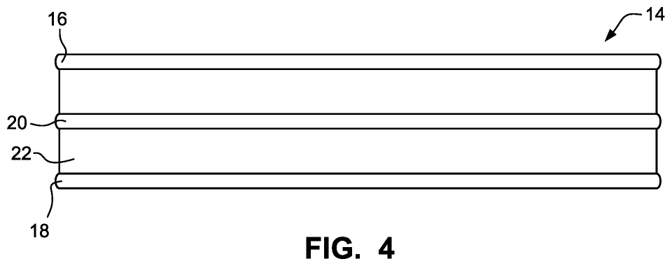

With reference to FIGS. 2-4, an awning shield connector 14 of the described embodiments is connected between the awning shield 10 and the vehicle or structure S. The awning shield connector 14 is provided in the form of an elongated strip preferably of PVC material. The connector 14 is extruded using known methods and is cut to desired lengths.

The connector 14 includes a first bead 16 along one side of the elongated strip that is shaped to engage the awning rail on the structure S. A second bead 18 is disposed along an opposite side of the elongated strip and is shaped to engage the awning shield 10. A third bead 20 is positioned between the first and second beads 16, 18 and extends along a length of the elongated strip.

In a preferred construction, the awning shield connector 14 is formed as a single piece of PVC material, and as such, the first, second and third beads 16, 18, 20 form an integral part of the elongated strip. As shown, the first and second beads 16, 18 are positioned along outermost sides of the elongated strip. A planar extension 22 exists between and connects the first and second beads 16, 18. In some embodiments, the third bead 20 extends from a stem 24 connected to the planar extension section 22. The stem 24 and thereby the third bead 20 may be angled relative to the planar extension section 22.

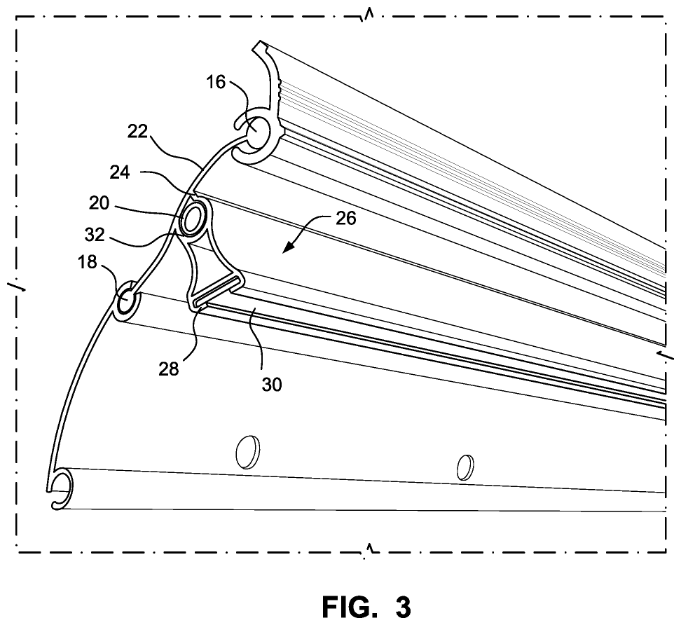

As shown in FIG. 3, a light strip assembly 26 may be detachably connected to the third bead 20. The light strip assembly 26 may be provided with a first channel 28 that secures a light strip 30 and a second channel 32 that is sized to fit over the third bead 20. The light strip assembly 26 serves to create illumination under the awning roller area and works when the canopy is open or closed. With the third bead 20 oriented at an angle, e.g., a 45 degree angle, a greater illumination area is created.

Due to the use of PVC material, the awning shield connector 14 of the described embodiments more easily and more effectively slides into corresponding channels in the awning rail and the awning shield. That is, to connect the awning shield 10 to the structure S, the first bead 16 may be slid into a channel in the awning rail on the structure S. Similarly, the second bead 18 is slid into a channel in the awning shield 10. These steps may be conducted in any order. The light strip assembly 26 is slid over the third bead 20. The PVC material is stable over environmental temperatures, so the connector can remain captured in the tracks/channels and will not expand to damage the tracks/channels.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An awning shield connector configured to connect an awning shield to a structure, the awning shield connector comprising an elongated strip of PVC material including a first bead along one side of the elongated strip and shaped to engage an awning rail on the structure, a second bead along an opposite side of the elongated strip and shaped to engage the awning shield, and a third bead positioned between the first and second beads and extending along a length of the elongated strip.

2. An awning shield connector according to claim 1, wherein the first, second and third beads form an integral part of the elongated strip.

3. An awning shield connector according to claim 1, wherein the first and second beads are positioned along outermost sides of the elongated strip.

4. An awning shield connector according to claim 3, further comprising a planar extension section between the first and second beads, wherein the third bead extends from a stem connected to the planar extension section.

5. An awning shield connector according to claim 4, wherein the stem and thereby the third bead are angled relative to the planar extension section.

6. An awning shield connector according to claim 1, further comprising a light strip assembly detachably connected to the third bead.

7. An awning shield connector according to claim 6, wherein the light strip assembly comprises a first channel securing a light strip, and a second channel sized to fit over the third bead.

8. An awning shield connector comprising:
a first bead extending along one side of the connector;
a second bead extending along an opposite side of the connector, the first and second beads defining outermost sides of the connector;
a planar extension section extending between the first bead and the second bead; and
a third bead disposed between the first and second beads and extending along a length of the connector.

9. An awning shield connector according to claim 8, wherein the first bead, the second bead, the planar extension, and the third bead are integrally formed.

10. An awning shield connector according to claim 9, wherein the first bead, the second bead, the planar extension, and the third bead define an elongated strip formed of PVC material.

11. An awning shield connector according to claim 8, wherein the third bead extends from a stem connected to the planar extension section.

12. An awning shield connector according to claim 11, wherein the stem and thereby the third bead are angled relative to the planar extension section.

13. An awning shield connector according to claim 8, further comprising a light strip assembly detachably connected to the third bead.

14. An awning shield connector according to claim 13, wherein the light strip assembly comprises a first channel securing a light strip, and a second channel sized to fit over the third bead.

15. A method of connecting an awning shield to a structure with an awning shield connector, the awning shield connector including an elongated strip of PVC material with a first bead along one side of the elongated strip, a second bead along an opposite side of the elongated strip, and a third bead positioned between the first and second beads and extending along a length of the elongated strip, the method comprising:
(a) sliding the first bead into a channel in an awning rail on the structure; and
(b) sliding the second bead into a channel in the awning shield.

16. A method according to claim 15, wherein step (b) is practiced before step (a).

17. A method according to claim 15, further comprising (c) sliding a light strip assembly over the third bead.

18. A method according to claim 17, wherein the light strip assembly comprises a first channel at one end and a second channel at an opposite end, and wherein step (c) is practiced by sliding the first channel over the third bead.

19. A method according to claim 18, further comprising securing a light strip in the second channel.
